(19) United States
(12) Patent Application Publication
(10) Pub. No.: US 2003/0147246 A1
(43) Pub. Date: Aug. 7, 2003

(54) Opaque windowsill cylindrical candle guard

(76) Inventor: Bonnie S. Clever, Circleville, OH (US)

Correspondence Address: William L. Archer, Jr., P.O. Box 482, Circleville, OH, 43113, US

(21) Appl. No.: 10/072,799

(22) Filed: Feb. 7, 2002

(51) Int. Cl. F21V 17/04

(52) U.S. Cl. 362/447

(57) ABSTRACT

The opaque windowsill cylindrical candle guard is a half cylinder object that holds a wax or electric candle on a windowsill for decoration, while it blocks the illumination back into the room. The cylinder attaches to the windowsill through tabs located at the bottom that slide between the windowsill and the window.

### RELATED APPLICATION

I am also requesting a design patent for this invention.

### FEDERALLY SPONSORED RESEARCH AND DEVELOPMENT

None

### BACKGROUND OF THE INVENTION

Candles and similar-sized lighting objects placed in windows for decoration project light inward and outward. Light projected inward is not conducive for bedrooms. This device permits the continual lighting of a candle or similar-sized lighting object during evening hours without projecting light to the interior of the room. Various colors and designs will be a decorative piece in any room.

### GENERAL DESCRIPTION OF INVENTION

An opaque, half-cylinder candle guard for directing light from windowsill-style candles or similar-sized lighting objects with strips that slip down in the space between the window and the windowsill to hold the candle guard vertical.

### DETAILED DESCRIPTION OF THE INVENTION

A half-cylinder 10 inches in length with a depth of 2⅛ inches and a width of 5¼ inches with strips 11 inches in length and 1 inch in width attached to or connected with the edges of the half-cylinder.

### FIGURE DESCRIPTIONS

I, Bonnie S. Clever, have invented a new design for a windowsill candle guard, as set forth in the following specification. The claimed windowsill candle guard is used to project candle light from candles in windowsills while blocking that light back into the house.

FIG. 1 indicates a top view of the device: a half circle, closed-in top with narrow strips to both sides of the half circle that do not extend above the half circle. The bottom view is identical to the top view except that the strips extend below the half circle.

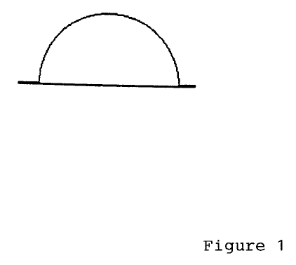

FIG. 2 indicates a frontal view of the device: a half circle with vertical edges that extend at the bottom of the half circle to fit into the space between the window and the windowsill.

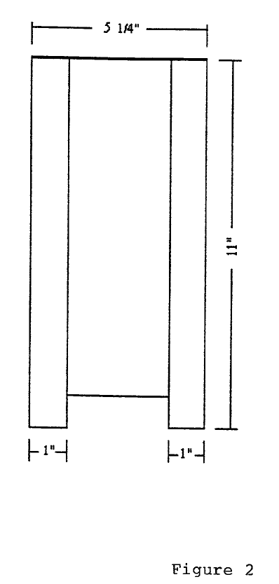

FIG. 3 indicates a side view: a rounded, quarter circle with a narrow extension at the bottom corner (left side view: the tab would be on the left bottom corner and the right side view: the tab would be on the right bottom corner).

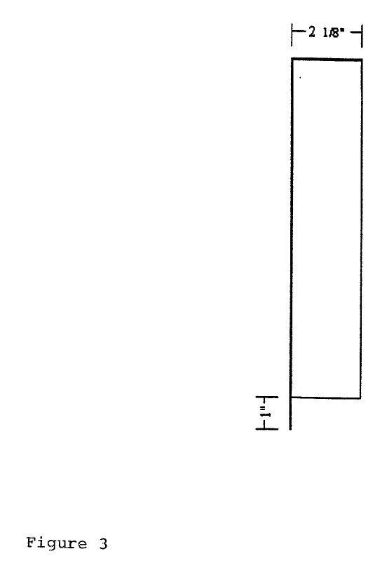

FIG. 4 indicates a three dimensional, front view of the device: a half circle with vertical edges that extend at the bottom of the half circle to fit into the space between the window and the windowsill, with a closed-in top and an open bottom.

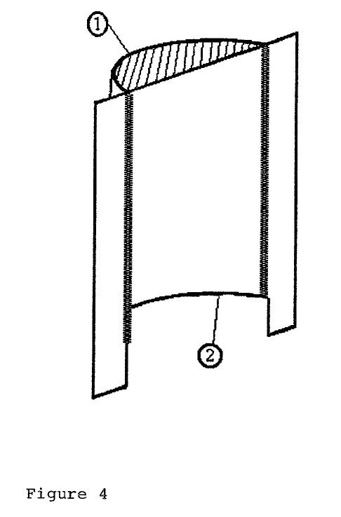

I claim the ornamental design for a windowsill candle guard as shown.

I declare that I am a citizen of United States of America.

I claim small entity status.

I claim:

1. The opaque cylindrical device surrounds a candle or similar-sized window lighting object.

2. The cylindrical device is manufactured in a multitude of materials that are opaque to block the interior lighting of a candle or similar-sized window-lighting object.

3. The opaque cylindrical device fits on a windowsill with the edges placed in between the window and windowsill.

4. The opaque cylindrical device projects the exterior lighting of a candle or similar-sized window-lighting object.

5. The opaque cylindrical device is a product with a decorative outer covering comprising the half circle facing inward from the window, which could include a multitude of colors and designs.

6. The opaque cylindrical device is not an independent luminary product. It requires a separate lighting object such as a candle or similar-sized object.
